(19) United States
(12) Patent Application Publication
(10) Pub. No.: US 2009/0282987 A1
(43) Pub. Date: Nov. 19, 2009

(54) SYSTEM, POD AND METHOD FOR PREPARING A BEVERAGE

(76) Inventors: Alistair John MacMahon, Oxfordshire (GB); Mark Norton, Oxfordshire (GB); Paul James Harpley, Oxfordshire (GB); Audrey Virginie Trouillot, Oxfordshire (DE); Amy Jane Stockwell, Oxfordshire (GB); Richard James Walker, Oxfordshire (GB)

Correspondence Address: FITCH EVEN TABIN & FLANNERY, 120 SOUTH LASALLE STREET, SUITE 1600, CHICAGO, IL, 60603-3406, US

(21) Appl. No.: 12/298,616

(22) PCT Filed: Apr. 27, 2007
(86) PCT No.: PCT/GB07/01550

§ 371 Date: Apr. 28, 2009

(30) Foreign Application Priority Data
Apr. 27, 2006 (GB) 0608351.3

(51) Int. Cl. A47J 31/44; A47J 31/00; B01F 3/04; B67D 5/00

(52) U.S. Cl. 99/288; 99/302 R; 99/295; 99/323.1; 222/1

(57) ABSTRACT

The present invention provides a system, pod and method for preparing a beverage containing extract from a water infusible ingredient and, in one preferred embodiment, provides: a system for preparing a beverage comprising: at least one compartment defining a storage volume for containing, or for receiving a pod containing, an extraction ingredient of roast and ground coffee for forming a beverage; and one or more jetting apertures arranged for jetting in use a liquid into the at least one compartment, wherein: the system operates in use at a pressure of less than 8.5×10⁵ Pa (8.5 bar); at least one of the one or more jetting apertures delivers in use a jet of liquid which impacts the extraction ingredient of roast and ground coffee at a speed in the range of 15 to 500×10⁻² m/s (15 to 500 cm/s); and the one or more jetting apertures comprise a total cross sectional area less than 16×10⁻⁶ m2 (16 mm²).

The present invention relates to a system, pod and method for preparing a beverage containing extract from a water infusible ingredient. The water infusible ingredient may be roast and ground coffee, leaf tea, herbal tea, fruit tea or any other such water infusible ingredient. The invention finds particular advantage where the water infusible ingredient is roast and ground coffee. The pods described herein are also known as pads, cartridges, capsules, pouches and bags.

Beverage preparation systems, in particular for preparing a coffee beverage, are well known in the art. It is also known to provide pods for use with beverage preparation machines, which pods contain a water infusible ingredient such as roast and ground coffee.

For example, cartridges or capsules containing compacted roast and ground coffee are known for use in certain coffee preparation machines which are generally termed “espresso” machines. In the production of a coffee beverage using this type of preparation machine, a cartridge containing a compacted bed of roast and ground coffee is placed in a brewing chamber and hot water is passed though the cartridge at relatively high pressures, thereby extracting the aromatic coffee constituents from the roast and ground coffee to produce the coffee beverage. Typically, such machines operate at pressures of at least 6×10⁵ Pa (6 bar). The beverage preparation machines of the type described have to date been relatively expensive and aimed at the commercial or industrial market, since components of the machine, such as the water pumps and seals, must be able to withstand the high pressures necessary to obtain a coffee beverage of acceptable quality. Likewise, the cartridges designed for use in such beverage preparation machines have been relatively expensive. An example of such a system is disclosed in EP 1042978 of Lavazza and marketed as Espresso Point.

In WO01/58786 of the present applicant, there is described a cartridge for use in a beverage preparation machine which operates at a lower pressure, generally in the range 0.7 to 2.0×10⁵ Pa (0.7 to 2.0 bar). However, the cartridge is nevertheless designed for use in a beverage preparation machine for the commercial or industrial market. Although such a system is cheaper than the “espresso” beverage machines and cartridges described above, it is still relatively expensive and not ideally suited to the domestic market.

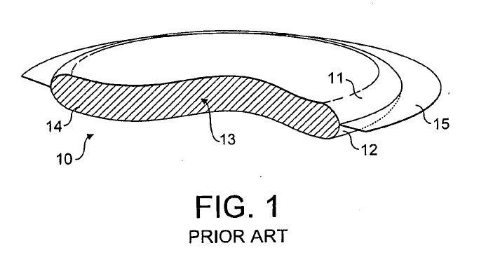

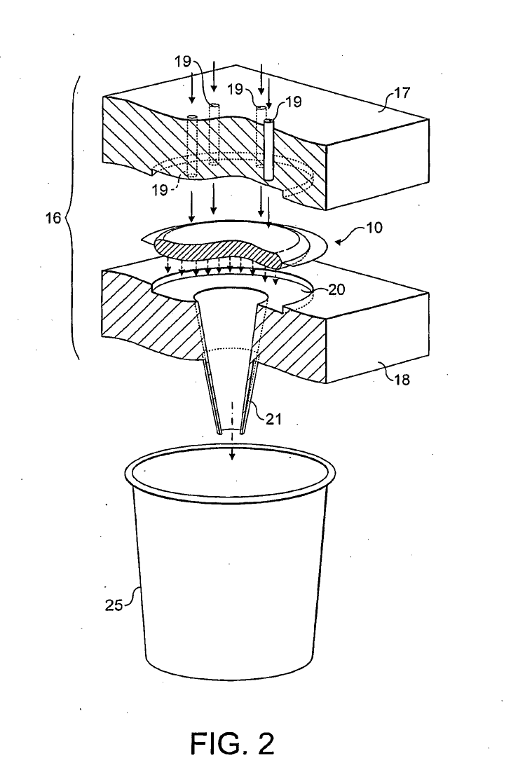

More recently, beverage preparation machines and cartridges operable at lower pressures have been introduced specifically for the domestic market. These machines are generally termed “on-demand” or “single-serve” beverage machines and make use of pods, in particular flexible pads, which contain a more loosely packed water infusible ingredient such as roast and ground coffee or leaf tea. Such beverage preparation machines and pods are suitable, in particular, for the domestic market in terms of cost, performance, simplicity of operation and reliability. A system of this type is illustrated schematically in FIGS. 1 and 2. The pad 10 is simple in construction and comprises a circular upper sheet 11 and a circular lower sheet 12 of filter material which are bonded together around a peripheral seam 15 to define and seal a storage volume 13 in which the water infusible substance 14 is contained. In use, the pad 10 is placed in a receiving compartment 20 of a beverage preparation machine 16, such as a coffee brewer, and clamped in place so as to prevent water bypass. Heated water is passed via outlets 19 in the brewer head 17 through the pad 10. The heated water flows through the upper sheet 11 and lower sheet 12 of filter material and in so doing contacts and infuses the water infusible substance 14 contained in the storage volume 13 to form a beverage. The beverage containing extract from the water infusible substance 14 then passes through the lower sheet 12 of the filter material and is dispensed via outlet 21 into a suitable receptacle 25. An example of such a system is disclosed in EP 1521541 of Seb S. A. and marketed as Home Café.

However, the lower operating pressures utilised in order to achieve the necessary cost, performance, simplicity of operation and reliability required for the domestic market in turn requires pods containing more loosely packed water infusible ingredients (when compared to the pods used with “espresso” type beverage machines). This combination of lower operating pressure and more loosely packed water infusible ingredients compromises to some degree the quality of the beverage obtained.

Hence, there remains a requirement for a system, pod and method for preparing a beverage where the quality of beverage obtained is improved without any compromise in the cost, performance, simplicity of operation and reliability required for the domestic market.

Accordingly, in a first aspect, the present invention provides a system for preparing a beverage comprising:

at least one compartment defining a storage volume for containing, or for receiving a pod containing, an extraction ingredient of roast and ground coffee for forming a beverage; and

one or more jetting apertures arranged for jetting in use a liquid into the at least one compartment, wherein:

the system operates in use at a pressure of less than 8.5×10⁵ Pa (8.5 bar);

at least one of the one or more jetting apertures delivers in use a jet of liquid which impacts the extraction ingredient of roast and ground coffee at a speed in the range of 15 to 500×10⁻² m/s (15 to 500 cm/s); and

the one or more jetting apertures comprise a total cross sectional area less than 16×10⁻⁶ m² (16 mm²).

Preferably, the at least one of the one or more jetting apertures delivers in use a jet of liquid which impacts the extraction ingredient of roast and ground coffee at a speed in the range of 30 to 200×10⁻² m/s (30 to 200 cm/s).

More preferably, the at least one of the one or more jetting apertures delivers in use a jet of liquid which impacts the extraction ingredient of roast and ground coffee at a speed in the range of 50 to 150×10⁻² m/s (50 to 150 cm/s).

Advantageously, the at least one of the one or more jetting apertures delivers in use a jet of liquid which impacts the extraction ingredient of roast and ground coffee at a speed of substantially 1.3 m/s (130 cm/s).

In a second aspect, the present invention provides a system for preparing a beverage comprising:

at least one compartment defining a storage volume for containing, or for receiving a pod containing, an extraction ingredient of roast and ground coffee for forming a beverage; and

one or more jetting apertures arranged for jetting in use a liquid into the at least one compartment, wherein:

at least one of the one or more jetting apertures delivers in use a jet of liquid which impacts the extraction ingredient of roast and ground coffee with a power in the range of 0.000075 to 0.15 J/s (750 to 1500000 erg/s); and

the one or more jetting apertures comprise a total cross sectional area less than 16×10⁻⁶ m² (16 mm²).

Preferably, the at least one of the one or more jetting apertures delivers in use a jet of liquid which impacts the extraction ingredient of roast and ground coffee with a power in the range of 0.0003 to 0.03 J/s (3000 to 300000 erg/s).

More preferably, the at least one of the one or more jetting apertures delivers in use a jet of liquid which impacts the extraction ingredient of roast and ground coffee with a power in the range of 0.0005 to 0.01 J/s (5000 to 100000 erg/s).

Advantageously, the at least one of the one or more jetting apertures delivers in use a jet of liquid which impacts the extraction ingredient of roast and ground coffee with a power of substantially 0.0062 J/s (62000 erg/s).

In a third aspect, the present invention provides a system for preparing a beverage comprising:

at least one compartment defining a storage volume for containing, or for receiving a pod containing, an extraction ingredient of roast and ground coffee for forming a beverage; and

one or more jetting apertures arranged for jetting in use a liquid into the at least one compartment, wherein:

at least one of the one or more jetting apertures delivers in use a jet of liquid which impacts the extraction ingredient of roast and ground coffee with a vorticity in the range of 8 to 500 per second; and

the one or more jetting apertures comprise a total cross sectional area less than 16×10⁻⁶ m² (16 mm²).

Preferably, the at least one of the one or more jetting apertures delivers in use a jet of liquid which impacts the extraction ingredient of roast and ground coffee with a vorticity in the range of 10 to 400 per second.

More preferably, the at least one of the one or more jetting apertures delivers in use a jet of liquid which impacts the extraction ingredient of roast and ground coffee with a vorticity in the range of 13 to 70 per second.

Advantageously, the at least one of the one or more jetting apertures delivers in use a jet of liquid which impacts the extraction ingredient of roast and ground coffee with a vorticity of substantially 54 per second.

In a fourth aspect, the present invention provides a system for preparing a beverage comprising:

at least one compartment defining a storage volume for containing, or for receiving a pod containing, an extraction ingredient of roast and ground coffee for forming a beverage; and

one or more jetting apertures arranged for jetting in use a liquid into the at least one compartment, wherein:

at least one of the one or more jetting apertures delivers in use a jet of liquid which impacts the extraction ingredient of roast and ground coffee;

the unit area of the extraction ingredient of roast and ground coffee available for the or each jet to impact is in the range of 0.02 to 0.6×10⁻⁶ m² (0.02 to 0.6 mm²); and

at least one of the one or more jetting apertures delivers in use a jet of liquid which impacts the extraction ingredient of roast and ground coffee at a speed in the range of 15 to 500×10⁻² m/s (15 to 500 cm/s).

Preferably, the unit area of the extraction ingredient of roast and ground coffee available for the or each jet to impact is in the range of 0.03 to 0.5×10⁻⁶ m² (0.03 to 0.5 mm²).

More preferably, the unit area of the extraction ingredient of roast and ground coffee available for the or each jet to impact is in the range of 0.05 to 0.3×10⁻⁶ m² (0.05 to 0.3 mm²).

Advantageously, the unit area of the extraction ingredient of roast and ground coffee available for the or each jet to impact is substantially 0.2×10⁻⁶ m² (0.2 mm²).

Preferably, the one or more jetting apertures comprise a total cross sectional area in the range of 0.5 to 16×10⁻⁶ m² (0.5 to 16 mm²).

More preferably, the one or more jetting apertures comprise a total cross sectional area in the range of 1 to 10×10⁻⁶ m² (1 to 10 mm²).

Advantageously, the one or more jetting apertures comprise a total cross sectional area in the range of 2 to 6×10⁻⁶ m² (2 to 6 mm²).

More advantageously, the one or more jetting apertures comprise a total cross sectional area of substantially 2.75×10⁻⁶ m² (2.75 mm²).

Preferably, the one or more jetting apertures comprises more than one jetting aperture.

More preferably, the one or more jetting apertures comprises between 3 and 70 jetting apertures.

Preferably, the one or more jetting apertures comprises between 8 and 36 jetting apertures.

Preferably, the one or more jetting apertures comprises between 10 and 20 jetting apertures.

Preferably, the one or more jetting apertures comprises 14 jetting apertures.

Alternatively, the one or more jetting apertures comprises 15 jetting apertures.

Alternatively, the one or more jetting apertures comprises 16 jetting apertures.

Alternatively, the one or more jetting apertures comprises 17 jetting apertures.

Alternatively, the one or more jetting apertures comprises 18 jetting apertures.

Alternatively, the one or more jetting apertures comprises 19 jetting apertures.

Alternatively, the one or more jetting apertures comprises 20 jetting apertures.

Alternatively, the one or more jetting apertures comprises only one jetting aperture.

Preferably, each jetting aperture is of substantially the same cross-sectional area.

Alternatively, at least two jetting apertures are of substantially different cross-sectional area.

Preferably, the extraction ingredient of roast and ground coffee is arranged in the form of a bed having a major cross sectional area, depth and aspect ratio of major cross sectional area to depth.

Preferably, the bed has a major cross sectional area in the range of 706 to 5026×10⁻⁶ m² (706 to 5026 mm²).

More preferably, the bed has a major cross sectional area in the range of 2376 to 3019×10⁻⁶ m² (2376 to 3019 mm²).

Advantageously, the bed has a major cross sectional area in the range of 1963 to 3848×10⁻⁶ m² (1963 to 3848 mm²).

More advantageously, the bed has a major cross sectional area of substantially 2734×10⁻⁶ m² (2734 mm²).

Preferably, the bed has a depth in the range of 2 to 50×10⁻³ m (2 to 50 mm).

More preferably, the bed has a depth in the range of 4 to 10×10⁻³ m (4 to 10 mm).

Advantageously, the bed has a depth in the range of 6 to 8×10⁻³ m (6 to 8 mm).

More advantageously, the bed has a depth of substantially 7×10⁻³ m (7 mm).

Preferably, the bed has a major cross sectional area to depth aspect ratio in the range of 14.1:1 to 2513:1.

More preferably, the bed has a major cross sectional area to depth aspect ratio in the range of 196:1 to 962:1.

Advantageously, the bed has a major cross sectional area to depth aspect ratio in the range of 297:1 to 503:1.

More advantageously, the bed has a major cross sectional area to depth aspect ratio of substantially 390:1.

Preferably, at least one of the one or more jetting apertures is/are arranged so as to deliver in use a jet of liquid in a direction substantially perpendicular to a plane lying in the major cross section of the bed.

Alternatively, at least one of the one or more jetting apertures is/are arranged so as to deliver in use a jet of liquid in a direction substantially parallel to a plane lying in the major cross section of the bed.

Alternatively, at least one of the one or more jetting apertures is/are arranged so as to deliver in use a jet of liquid in a direction non-perpendicular and/or non-parallel to a plane lying in the major cross section of the bed.

Preferably, the mass of the extraction ingredient of roast and ground coffee is in the range of 4 to 15×10⁻³ kg (4 to 15 g).

More preferably, the mass of the extraction ingredient of roast and ground coffee is in the range of 5 to 8×10⁻³ kg (5 to 8 g).

Advantageously, the mass of the extraction ingredient of roast and ground coffee is substantially 7×10⁻³ kg (7 g).

Preferably, the brew weight of the beverage is in the range of 30 to 330×10⁻³ kg (30 to 330 g).

More preferably, the brew weight of the beverage is in the range of 90 to 240×10⁻³ kg (90 to 240 g).

Advantageously, the brew weight of the beverage is substantially 96×10⁻³ kg (96 g).

Preferably, the brew volume of the beverage is in the range of 30 to 330×10⁻³ l (30 to 330 ml).

More preferably, the brew volume of the beverage is in the range of 90 to 240×10⁻³ l (90 to 240 ml).

Advantageously, the brew volume of the beverage is substantially 96×10⁻³ l (96 ml).

Preferably, the mass flow rate of the beverage is in the range of 1 to 6×10⁻³ kg/s (1 to 6 g/s).

More preferably, the mass flow rate of the beverage is in the range of 2 to 4×10⁻³ kg/s (2 to 4 g/s).

Advantageously, the mass flow rate of the beverage is substantially 3.6×10⁻³ kg/s (3.6 g/s).

Preferably, the volumetric flow rate of the beverage is in the range of 1 to 6×10⁻⁶ m³/s (1 to 6 cm³/s).

More preferably, the volumetric flow rate of the beverage is in the range of 2 to 4×10⁻⁶ m³/s (2 to 4 cm³/s).

Advantageously, the volumetric flow rate of the beverage is substantially 3.6×10⁻⁶ m³/s (3.6 cm³/s).

Preferably, the system further comprises at least one fluid conduit for connecting the one or more jetting apertures to a liquid supply and conveying in use liquid from the liquid supply to the one or more jetting apertures.

Preferably, the system further comprises a liquid heater, wherein in use the liquid is heated by the liquid heater to a temperature in the range of 70 to 98° C. prior to delivery as a jet of liquid.

More preferably, the liquid is heated by the liquid heater to a temperature in the range of 75 to 96° C. prior to delivery as a jet of liquid.

Advantageously, the liquid is heated by the liquid heater to a temperature in the range of 80 to 95° C. prior to delivery as a jet of liquid.

More advantageously, the liquid is heated by the liquid heater to a temperature of substantially 88° C. prior to delivery as a jet of liquid.

Preferably, the system further comprises a liquid pump, wherein in use the liquid is pressurised by the liquid pump to a pressure in the range of 0.5 to 8.5×10⁵ Pa (0.5 to 8.5 bar) prior to delivery as a jet of liquid.

More preferably, the liquid is pressurised by the liquid pump to a pressure in the range of 0.8 to 3.0×10⁵ Pa (0.8 to 3 bar) prior to delivery as a jet of liquid.

Advantageously, the liquid is pressurised by the liquid pump to a pressure in the range of 0.9 to 2.5×10⁵ Pa (0.9 to 2.5 bar) prior to delivery as a jet of liquid.

More advantageously, the liquid is pressurised by the liquid pump to a pressure of substantially 1.2×10⁶ Pa (1.2 bar) prior to delivery as a jet of liquid.

Preferably, at least one of the one or more jetting apertures delivers in use a jet of liquid as a discontinuous flow. Preferably, the discontinuous flow is a pulsed flow.

Preferably, the liquid comprises an aqueous medium. More preferably, the aqueous medium comprises water or is water. Advantageously, the aqueous medium comprises an extract of roast and ground coffee.

Alternatively, the liquid comprises a non-aqueous medium. Preferably, the non-aqueous medium comprises alcohol or is alcohol.

Preferably, the cross sectional area of the one or more jetting apertures is/are dynamic and can be varied in use. More preferably, the cross sectional area of the one or more jetting apertures varies automatically in use in dependence upon the temperature of the fluid passing through the jetting aperture.

Preferably, the one or more jetting apertures are formed in or from any one or more of the following materials: polypropylene, polyester, polystyrene, nylon, polyurethane, acetal, acetal grade polyoxylene methylene copolymer (e.g. Centrodal C), polymers (e.g. polypropylene, polystyrene, polyamide, polyvinyl chloride, polyethylene and its derivatives and mixtures thereof), other engineering plastics, composites, ceramics, aluminium grade HE30, stainless steel, brass, other metals, metal-plastic composites, card, wood, rubber or biodegradable plastics such as degradable polyethylene (for example, SPITEK supplied by Symphony Environmental, Borehamwood, United Kingdom), biodegradable polyester amide (for example, BAK 1095 supplied by Symphony Environmental), poly lactic acids (PLA supplied by Cargill, Minnesota, USA), starch-based polymers, cellulose derivatives, polypeptides, polypropylene homo polymer for injection moulding (e.g. Sabic PP 579S).

In a fifth aspect, the present invention provides a pod for preparing a beverage comprising:

at least one compartment defining a storage volume for containing an extraction ingredient of roast and ground coffee for forming a beverage;

the at least one compartment comprising an inlet surface containing one or more jetting apertures forming an inlet into the compartment, and an outlet surface formed at least partially from filtering material, the filtering material forming an outlet of the pod; and

the one or more jetting apertures of the inlet of the at least one compartment are arranged for jetting in use a liquid into the at least one compartment, wherein:

the pod operates in use at a pressure of less than 8.5×10⁵ Pa (8.5 bar);

at least one of the one or more jetting apertures delivers in use a jet of liquid which impacts the extraction ingredient of roast and ground coffee contained in the at least one compartment at a speed in the range of 15 to 500×10⁻² m/s (15 to 500 cm/s); and

the one or more jetting apertures comprise a total cross sectional area less than 16×10⁻⁶ m² (16 mm²).

Preferably, the at least one of the one or more jetting apertures delivers in use a jet of liquid which impacts the extraction ingredient of roast and ground coffee contained in the at least one compartment at a speed in the range of 30 to 200×10 m⁻² m/s (30 to 200 cm/s).

More preferably, the at least one of the one or more jetting apertures delivers in use a jet of liquid which impacts the extraction ingredient of roast and ground coffee contained in the at least one compartment at a speed in the range of 50 to 150×10⁻² m/s (50 to 150 cm/s).

Advantageously, the at least one of the one or more jetting apertures delivers in use a jet of liquid which impacts the extraction ingredient of roast and ground coffee contained in the at least one compartment at a speed of substantially 1.3 m/s (130 cm/s).

In a sixth aspect, the present invention provides a pod for preparing a beverage comprising:

at least one compartment defining a storage volume for containing an extraction ingredient of roast and ground coffee for forming a beverage;

the at least one compartment comprising an inlet surface containing one or more jetting apertures forming an inlet into the compartment, and an outlet surface formed at least partially from filtering material, the filtering material forming an outlet of the pod; and

the one or more jetting apertures of the inlet of the at least one compartment are arranged for jetting in use a liquid into the at least one compartment, wherein:

at least one of the one or more jetting apertures delivers in use a jet of liquid which impacts the extraction ingredient of roast and ground coffee contained in the at least one compartment with a power in the range of 0.000075 to 0.15 J/s (750 to 1500000 erg/s); and

the one or more jetting apertures comprise a total cross sectional area less than 16×10^{-6 m}² (16 mm²).

Preferably, at least one of the one or more jetting apertures delivers in use a jet of liquid which impacts the extraction ingredient of roast and ground coffee contained in the at least one compartment with a power in the range of 0.0003 to 0.03 J/s (3000 to 300000 erg/s).

More preferably, the at least one of the one or more jetting apertures delivers in use a jet of liquid which impacts the extraction ingredient of roast and ground coffee contained in the at least one compartment with a power in the range of 0.0005 to 0.01 J/s (5000 to 100000 erg/s).

Advantageously, the at least one of the one or more jetting apertures delivers in use a jet of liquid which impacts the extraction ingredient of roast and ground coffee contained in the at least one compartment with a power of substantially 0.00062 J/s (62000 erg/s).

In a seventh aspect, the present invention provides a pod for preparing a beverage comprising:

at least one compartment defining a storage volume for containing an extraction ingredient of roast and ground coffee for forming a beverage;

the at least one compartment comprising an inlet surface containing one or more jetting apertures forming an inlet into the compartment, and an outlet surface formed at least partially from filtering material, the filtering material forming an outlet of the pod; and

the one or more jetting apertures of the inlet of the at least one compartment are arranged for jetting in use a liquid into the at least one compartment, wherein:

at least one of the one or more jetting apertures delivers in use a jet of liquid which impacts the extraction ingredient of roast and ground coffee contained in the at least one compartment with a vorticity in the range of 8 to 500 per second; and

the one or more jetting apertures comprise a total cross sectional area less than 16×10⁻⁶ m² (16 mm²).

Preferably, the at least one of the one or more jetting apertures delivers in use a jet of liquid which impacts the extraction ingredient of roast and ground coffee contained in the at least one compartment with a vorticity in the range of 10 to 400 per second.

More preferably, the at least one of the one or more jetting apertures delivers in use a jet of liquid which impacts the extraction ingredient of roast and ground coffee contained in the at least one compartment with a vorticity in the range of 13 to 70 per second.

Advantageously, the at least one of the one or more jetting apertures delivers in use a jet of liquid which impacts the extraction ingredient of roast and ground coffee contained in the at least one compartment with a vorticity of substantially 54 per second.

In an eighth aspect, the present invention provides a pod for preparing a beverage comprising:

at least one compartment defining a storage volume for containing an extraction ingredient of roast and ground coffee for forming a beverage;

the at least one compartment comprising an inlet surface containing one or more jetting apertures forming an inlet into the compartment, and an outlet surface formed at least partially from filtering material, the filtering material forming an outlet of the pod; and

the one or more jetting apertures of the inlet of the at least one compartment are arranged for jetting in use a liquid into the at least one compartment, wherein:

at least one of the one or more jetting apertures delivers in use a jet of liquid which impacts the extraction ingredient of roast and ground coffee contained in the at least one compartment;

the unit area of the extraction ingredient of roast and ground coffee available for the or each jet to impact is in the range of 0.02 to 0.6×10⁻⁶ m² (0.02 to 0.6 mm²); and

at least one of the one or more jetting apertures delivers in use a jet of liquid which impacts the extraction ingredient of roast and ground coffee at a speed in the range of 15 to 500×10⁻² m/s (15 to 500 cm/s).

Preferably, the unit area of the extraction ingredient of roast and ground coffee available for the or each jet to impact is in the range of 0.03 to 0.5×10⁻⁶ m² (0.03 to 0.5 mm²).

More preferably, the unit area of the extraction ingredient of roast and ground coffee available for the or each jet to impact is in the range of 0.05 to 0.3×10⁻⁶ m² (0.05 to 0.3 mm²).

Advantageously, the unit area of the extraction ingredient of roast and ground coffee available for the or each jet to impact is substantially 0.2×10⁻⁶ m² (0.2 mm²).

Preferably, the one or more jetting apertures comprise a total cross sectional area in the range of 0.5 to 16×10⁻⁶ m² (0.5 to 16 mm²).

More preferably, the one or more jetting apertures comprise a total cross sectional area in the range of 1 to 10×10⁻⁶ m² (1 to 10 mm²).

Advantageously, the one or more jetting apertures comprise a total cross sectional area in the range of 2 to 6×10⁻⁶ m² (2 to 6 mm²).

More advantageously, the one or more jetting apertures comprise a total cross sectional area of substantially 2.75×10⁻⁶ m² (2.75 mm²).

Preferably, the one or more jetting apertures comprises more than one jetting aperture.

More preferably, the one or more jetting apertures comprises between 3 and 70 jetting apertures.

Preferably, the one or more jetting apertures comprises between 8 and 36 jetting apertures.

Preferably, the one or more jetting apertures comprises between 10 and 20 jetting apertures.

Preferably, the one or more jetting apertures comprises 14 jetting apertures.

Alternatively, the one or more jetting apertures comprises 15 jetting apertures.

Alternatively, the one or more jetting apertures comprises 16 jetting apertures.

Alternatively, the one or more jetting apertures comprises 17 jetting apertures.

Alternatively, the one or more jetting apertures comprises 18 jetting apertures.

Alternatively, the one or more jetting apertures comprises 19 jetting apertures.

Alternatively, the one or more jetting apertures comprises 20 jetting apertures.

Alternatively, the one or more jetting apertures comprises only one jetting aperture.

Preferably, each jetting aperture is of substantially the same cross-sectional area.

Alternatively, at least two jetting apertures are of substantially different cross-sectional area.

Preferably, the extraction ingredient of roast and ground coffee contained in the at least one compartment is arranged in the form of a bed having a major cross sectional area, depth and aspect ratio of major cross sectional area to depth.

Preferably, the bed has a major cross sectional area in the range of 706 to 5026×10⁻⁶ m² (706 to 5026 mm²).

More preferably, the bed has a major cross sectional area in the range of 1963 to 3848×10⁻⁶ m² (1963 to 3848 mm²).

Advantageously, the bed has a major cross sectional area in the range of 2376 to 3019×10⁻⁶ m² (2376 to 3019 mm²).

More advantageously, the bed has a major cross sectional area of substantially 2734×10⁻⁶ m² (2734 mm²).

Preferably, the bed has a depth in the range of 2 to 50×10⁻³ m (2 to 50 mm).

More preferably, the bed has a depth in the range of 4 to 10×10⁻³ m (4 to 10 mm).

Advantageously, the bed has a depth in the range of 6 to 8×10⁻³ m (6 to 8 mm).

More advantageously, the bed has a depth of substantially 7×10⁻³ m (7 mm).

Preferably, the bed has a major cross sectional area to depth aspect ratio in the range of 14.1:1 to 2513:1.

More preferably, the bed has a major cross sectional area to depth aspect ratio in the range of 196:1 to 962:1.

Advantageously, the bed has a major cross sectional area to depth aspect ratio in the range of 297:1 to 503:1.

More advantageously, the bed has a major cross sectional area to depth aspect ratio of substantially 390:1.

Preferably, at least one of the one or more jetting apertures is/are arranged so as to deliver in use a jet of liquid in a direction substantially perpendicular to a plane lying in the major cross section of the bed.

Alternatively, at least one of the one or more jetting apertures is/are arranged so as to deliver in use a jet of liquid in a direction substantially parallel to a plane lying in the major cross section of the bed.

Alternatively, at least one of the one or more jetting apertures is/are arranged so as to deliver in use a jet of liquid in a direction non-perpendicular and/or non-parallel to a plane lying in the major cross section of the bed.

Preferably, the mass of the extraction ingredient of roast and ground coffee is in the range of 4 to 15×10⁻³ kg (4 to 15 g).

More preferably, the mass of the extraction ingredient of roast and ground coffee is in the range of 5 to 8×10⁻³ kg (5 to 8 g).

Advantageously, the mass of the extraction ingredient of roast and ground coffee is substantially 7×10⁻³ kg (7 g).

Preferably, the brew weight of the beverage is in the range of 30 to 330×10⁻³ kg (30 to 330 g).

More preferably, the brew weight of the beverage is in the range of 90 to 240×10⁻³ kg (90 to 240 g).

Advantageously, the brew weight of the beverage is substantially 96×10⁻³ kg (96 g).

Preferably, the brew volume of the beverage is in the range of 30 to 330×10⁻³ l (30 to 330 ml).

More preferably, the brew volume of the beverage is in the range of 90 to 240×10⁻³ l (90 to 240 ml).

Advantageously, the brew volume of the beverage is substantially 96×10⁻³ l (96 ml).

Preferably, the mass flow rate of the beverage is in the range of 1 to 6×10⁻³ kg/s (1 to 6 g/s).

More preferably, the mass flow rate of the beverage is in the range of 2 to 4×10⁻³ kg/s (2 to 4 g/s).

Advantageously, the mass flow rate of the beverage is substantially 3.6×10⁻³ kg/s (3.6 g/s).

Preferably, the volumetric flow rate of the beverage is in the range of 1 to 6×10⁻⁶ m³/s (1 to 6 cm³/s).

More preferably, the volumetric flow rate of the beverage is in the range of 2 to 4×10⁻⁶ m³/s (2 to 4 cm³/s).

Advantageously, the volumetric flow rate of the beverage is substantially 3.6×10⁻⁶ m³/s (3.6 cm³/s).

Preferably, in use the liquid is of a temperature in the range of 70 to 98+ C. prior to delivery as a jet of liquid.

More preferably, the liquid is of a temperature in the range of 75 to 96° C. prior to delivery as a jet of liquid.

Advantageously, the liquid is of a temperature in the range of 80 to 95° C. prior to delivery as a jet of liquid.

More advantageously, the liquid is of a temperature of substantially 88° C. prior to delivery as a jet of liquid.

Preferably, in use the liquid is pressurised to a pressure in the range of 0.5 to 8.5×10⁵ Pa (0.5 to 8.5 bar) prior to delivery as a jet of liquid.

More preferably, the liquid is pressurised to a pressure in the range of 0.8 to 3.0×10⁵ Pa (0.8 to 3 bar) prior to delivery as a jet of liquid.

Advantageously, the liquid is pressurised to a pressure in the range of 0.9 to 2.5×10⁵ Pa (0.9 to 2.5 bar) prior to delivery as a jet of liquid.

More advantageously, the liquid is pressurised to a pressure of substantially 1.2×10⁶ Pa (1.2 bar) prior to delivery as a jet of liquid.

Preferably, at least one of the one or more jetting apertures delivers in use a jet of liquid as a discontinuous flow. Preferably, the discontinuous flow is a pulsed flow.

Preferably, in use the liquid comprises an aqueous medium. More preferably, the aqueous medium comprises water or is water. Advantageously, the aqueous medium comprises an extract of roast and ground coffee.

Alternatively, in use the liquid comprises a non-aqueous medium. Preferably, the non-aqueous medium comprises alcohol or is alcohol.

Preferably, the cross sectional area of the one or more jetting apertures is/are dynamic and can be varied in use. More preferably, the cross sectional area of the one or more jetting apertures varies automatically in use in dependence upon the temperature of the fluid passing through the jetting aperture.

Preferably the inlet surface of the at least one compartment is substantially rigid or semi-rigid.

Preferably, the inlet surface of the at least one compartment comprises any one or more of polypropylene, polyester, polystyrene, nylon, polyurethane, acetal, acetal grade polyoxylene methylene copolymer (e.g. Centrodal C), polymers (e.g. polypropylene, polystyrene, polyamide, polyvinyl chloride, polyethylene and its derivatives and mixtures thereof, other engineering plastics, composites, ceramics, aluminium grade HE30, stainless steel, brass, other metals, metal-plastic composites, card, wood, rubber or biodegradable plastics such as degradable polyethylene (for example, SPITEK supplied by Symphony Environmental, Borehamwood, United Kingdom), biodegradable polyester amide (for example, BAK 1095 supplied by Symphony Environmental), poly lactic acids (PLA supplied by Cargill, Minnesota, USA), starch-based polymers, cellulose derivatives, polypeptides, polypropylene homo polymer for injection moulding (e.g. Sabic PP 579S).

Preferably, the inlet surface of the at least one compartment is substantially flexible.

Preferably, the inlet surface comprises a thin, flexible, sheet of food grade material with low porosity.

Preferably, the inlet surface comprises any one or more of polyethylene, polypropylene, polyesters including polyethylene terephthalate, polyvinyl chloride, polyvinylidene chloride, polyamides including nylon, polyurethane, paper, viscose and/or foil.

The inlet surface may comprise a laminate, be metallised or formed of copolymers.

Preferably, the pod further comprises sealing means for sealing in use the pod against a wall of a brewer chamber or apparatus.

Preferably, the outlet permits in use free flow of liquid extract out of the pod.

Preferably, the filtering material is bonded to a flange, located at or around an edge of the at least one compartment, a side wall of the at least one compartment, or a lower surface of a side wall of the at least one compartment.

Preferably, the whole of the lower surface is formed from filtering material.

Alternatively, a portion of the lower surface is non-transmissive to liquid and another portion is formed from the filtering material. Preferably, the portion of filtering material is located at or near a centre of the lower surface. Alternatively, the portion of filtering material is an annulus located at a defined radius from the centre of the pod. Alternatively, the portion of filtering material is at a periphery of the lower surface.

Advantageously, the inlet surface of the at least one compartment is concave, convex, or planar in relation to the at least one compartment.

Preferably, the pod further comprises one or more layers of filtering material adjacent the inlet surface of the at least one compartment.

Preferably, the pod further comprises one or more layers of filtering material adjacent the outlet of the at least one compartment.

Advantageously, the pod further comprises one or more layers of filtering material adjacent both sides of the inlet surface of the at least one compartment.

Preferably, the jetting apertures of the inlet surface are associated with a support means for maintaining a spatial arrangement of the jetting apertures. Advantageously, the support means comprises a mesh, grid or similar structure. Alternatively, the support means comprises localised reinforcing of the inlet surface of the at least one compartment.

Preferably, the inlet surface of the at least one compartment is formed from a filtering material and the localised reinforcing is in the form of rigid or semi-rigid elements associated with or surrounding at least some of the jetting apertures.

Preferably, the at least one compartment comprises a rigid or semi-rigid sidewall. Advantageously, the rigid or semi-rigid sidewall maintains a physical separation of the filtering material and the inlet surface of the at least one compartment.

Preferably, the jetting apertures of the inlet are located in at least two discrete regions of the inlet surface of the at least one compartment. More preferably, the jetting apertures of the inlet are located at or near a centre of the inlet surface of the at least one compartment and a portion of the jetting apertures of the inlet are located in a random or uniform arrangement across the inlet surface of the at least one compartment. The jetting apertures of the inlet may be arranged in concentric circles.

Preferably, at least some of the jetting apertures are directed downwards at 90 degrees to the horizontal of, or perpendicular to, the inlet surface of the at least one compartment.

Advantageously, the storage volume further contains a dispersion plate associated with the outlet for creating a non-vertical flow or circulating flow of liquid, in use, within the storage volume. Preferably, the dispersion. plate is freely suspended within the storage volume. Alternatively, the dispersion plate is attached to the filtering material of the outlet. Advantageously, the dispersion plate forms part of the lower surface. Preferably, the dispersion plate is planar. Alternatively, the dispersion plate is rippled, ridged or otherwise convoluted. Preferably, the dispersion plate is non-apertured. Alternatively, the dispersion plate comprises one or more apertures. Advantageously, the dispersion plate is sealed or bonded to the lower surface and the one or more apertures are formed at the boundary between the dispersion plate and the outlet filtering means. Preferably, the dispersion plate comprises a portion of the outlet filtering means which has modified material characteristics and is non-transmissive to water. Preferably, the outlet filtering means comprises a filter material and the dispersion plate comprises a portion of the filter material which is hot stamped to render it impermeable to water. Advantageously, the pod comprises more than one dispersion plate.

Preferably, the pod is substantially circular with a diameter of between 0.03 and 0.11 m.

Preferably, the storage volume further contains one or more absorbent elements or particles or foamed plastic elements or particles. Advantageously, the absorbent elements or particles are spongiform. More advantageously, the absorbent elements or particles are an hydrogel, a starch, a spongiform material or a combination or mixture thereof. Preferably, before exposure to liquid, the one or more absorbent elements or particles or foamed plastic elements or particles are compressed. Preferably, in use, the one or more spongiform elements act as an absorbent means for retaining excess moisture. Preferably, the pod contains a single spongiform or hydrogel element or foamed plastic element. Preferably, the one or more absorbent elements or particles interact with water in use such as to absorb liquid only during a portion of a dispense cycle. Preferably, the one or more absorbent elements or particles interact with liquid at a predetermined temperature, pH or a start of a specified chemical reaction. More preferably, the one or more absorbent elements or particles comprise a soluble coating which, in use, is dissolvable in liquid to allow absorption of liquid to take place. Preferably, the soluble coating comprises sugar or gelatine.

Preferably, the storage volume further contains one or more bead elements or bead particles which are substantially incompressible. Preferably, the one or more bead elements or bead particles are inert. More preferably, the one or more bead elements or bead particles are coated with a dissolvable ingredient which dissolves in use in the liquid and/or liquid extract.

Preferably, the pod further comprises means at or near an outlet for the beverage for foaming the beverage. Preferably, the means for foaming the beverage is an aperture for forming a jet of beverage and subsequently impacting said jet of beverage against an impingement surface so as to produce foaming of the beverage. Advantageously, the means for foaming the beverage comprises a sintered outlet nozzle, or zeolite bed, membrane, eductor or venturi ejector.

Preferably, the pod further comprises a gasket seal for sealing, in use, against a pod holder of a beverage preparation machine in which the pod is used. Preferably, the pod further comprises a peripheral seal on an outer surface of the at least one compartment for sealing, in use, against a pod holder of a beverage preparation machine in which the pod is used. Advantageously, the pod further comprises a seal on or adjacent a lower or upper edge of the at least one compartment for sealing, in use, against a pod holder of a beverage preparation machine in which the pod is used.

Preferably, the at least one compartment is a unitary compartment. Alternatively, the at least one compartment comprises a plurality of compartments. Preferably, the at least one compartment comprises one or more baffles. Advantageously, the pod further comprises a cover for sealing the at least one compartment. More advantageously, the cover comprises a push-fit lid, or a peelable or tearable laminate. Preferably, the cover is formed at least partially from a filtering material and provides an inlet to the upper compartment.

Preferably, in use, brewing and filtering of the beverage occurs in an inverse manner, against the force of gravity.

In a ninth aspect, the present invention provides a method of dispensing a beverage using the pod comprising the step of passing liquid downwardly through the pod such that beverage initially exits the pod through a lowermost surface thereof.

In a tenth aspect, the present invention provides a method of dispensing a beverage using the pod comprising the step of passing liquid upwardly through the pod such that beverage initially exits the pod through an uppermost surface thereof.

In an eleventh aspect, the present invention provides a method of dispensing a beverage using the pod comprising the step of orientating the pod in a non-horizontal orientation and passing liquid in a non-vertical direction through the pod.

In a twelfth aspect, the present invention provides a use of the system to prepare a roast and ground coffee extract.

In a thirteenth aspect, the present invention provides a use of the pod to prepare a roast and ground coffee extract.

In a fourteenth aspect, the present invention provides a system for preparing a beverage comprising:

at least one compartment defining a storage volume for containing, or for receiving a pod containing, an infusion or extraction ingredient or combination, mixture or composition of infusion or extraction ingredients for forming a beverage; and

one or more jetting apertures arranged for jetting in use a liquid into the at least one compartment, wherein:

the system operates in use at a pressure of less than 8.5×10⁵ Pa (8.5 bar);

at least one of the one or more jetting apertures delivers in use a jet of liquid which impacts the infusion or extraction ingredient or combination, mixture or composition of infusion or extraction ingredients at a speed in the range of 15 to 500×10⁻² m/s (15 to 500 cm/s); and

the one or more jetting apertures comprise a total cross sectional area less than 16×10⁻⁶ m² (16 mm²).

In a fifteenth aspect, the present invention provides a system for preparing a beverage comprising:

at least one compartment defining a storage volume for containing, or for receiving a pod containing, an infusion or extraction ingredient or combination, mixture or composition of infusion or extraction ingredients for forming a beverage; and

one or more jetting apertures arranged for jetting in use a liquid into the at least one compartment, wherein:

at least one of the one or more jetting apertures delivers in use a jet of liquid which impacts the infusion or extraction ingredient or combination, mixture or composition of infusion or extraction ingredients with a power in the range of 0.000075 to 0.15 J/s (750 to 1500000 erg/s); and

the one or more jetting apertures comprise a total cross sectional area less than 16×10⁻⁶ m² (16 mm²).

In a sixteenth aspect, the present invention provides a system for preparing a beverage comprising:

at least one compartment defining a storage volume for containing, or for receiving a pod containing, an infusion or extraction ingredient or combination, mixture or composition of infusion or extraction ingredients for forming a beverage; and

one or more jetting apertures arranged for jetting in use a liquid into the at least one compartment, wherein:

at least one of the one or more jetting apertures delivers in use a jet of liquid which impacts the infusion or extraction ingredient or combination, mixture or composition of infusion or extraction ingredients with a vorticity in the range of 8 to 500 per second; and

the one or more jetting apertures comprise a total cross sectional area less than 16×10⁻⁶ m² (16 mm²).

In a seventeenth aspect, the present invention provides a system for preparing a beverage comprising:

at least one compartment defining a storage volume for containing, or for receiving a pod containing, an infusion or extraction ingredient or combination, mixture or composition of infusion or extraction ingredients for forming a beverage; and

one or more jetting apertures arranged for jetting in use a liquid into the at least one compartment, wherein:

at least one of the one or more jetting apertures delivers in use a jet of liquid which impacts the infusion or extraction ingredient or combination, mixture or composition of infusion or extraction ingredients;

the unit area of the infusion or extraction ingredient or combination, mixture or composition of infusion or extraction ingredients available for the or each jet to impact is in the range of 0.02 to 0.6×10⁻⁶ m² (0.02 to 0.6 mm²); and

at least one of the one or more jetting apertures delivers in use a jet of liquid which impacts the infusion or extraction ingredient or combination, mixture or composition of infusion or extraction ingredients at a speed in the range of 15 to 500×10⁻² m/s (15 to 500 cm/s).

In an eighteenth aspect, the present invention provides a pod for preparing a beverage comprising:

at least one compartment defining a storage volume for containing an infusion or extraction ingredient or combination, mixture or composition of infusion or extraction ingredients for forming a beverage;

the at least one compartment comprising an inlet surface containing one or more jetting apertures forming an inlet into the compartment, and an outlet surface formed at least partially from filtering material, the filtering material forming an outlet of the pod; and

the one or more jetting apertures of the inlet of the at least one compartment are arranged for jetting in use a liquid into the at least one compartment, wherein:

the pod operates in use at a pressure of less than 8.5×10⁵ Pa (8.5 bar);

at least one of the one or more jetting apertures delivers in use a jet of liquid which impacts the infusion or extraction ingredient or combination, mixture or composition of infusion or extraction ingredients contained in the at least one compartment at a speed in the range of 15 to 500×10⁻² m/s (15 to 500 cm/s); and

the one or more jetting apertures comprise a total cross sectional area less than 16×10⁻⁶ m² (16 mm²).

In a nineteenth aspect, the present invention provides a pod for preparing a beverage comprising:

at least one compartment defining a storage volume for containing an infusion or extraction ingredient or combination, mixture or composition of infusion or extraction ingredients for forming a beverage;

the at least one compartment comprising an inlet surface containing one or more jetting apertures forming an inlet into the compartment, and an outlet surface formed at least partially from filtering material, the filtering material forming an outlet of the pod; and

the one or more jetting apertures of the inlet of the at least one compartment are arranged for jetting in use a liquid into the at least one compartment, wherein:

at least one of the one or more jetting apertures delivers in use a jet of liquid which impacts the infusion or extraction ingredient or combination, mixture or composition of infusion or extraction ingredients contained in the at least one compartment with a power in the range of 0.000075 to 0.15 J/s (750 to 1500000 erg/s); and

the one or more jetting apertures comprise a total cross sectional area less than 16×10⁻⁶ m² (16 mm²).

In a twentieth aspect, the present invention provides a pod for preparing a beverage comprising:

at least one compartment defining a storage volume for containing an infusion or extraction ingredient or combination, mixture or composition of infusion or extraction ingredients for forming a beverage;

the at least one compartment comprising an inlet surface containing one or more jetting apertures forming an inlet into the compartment, and an outlet surface formed at least partially from filtering material, the filtering material forming an outlet of the pod; and

the one or more jetting apertures of the inlet of the at least one compartment are arranged for jetting in use a liquid into the at least one compartment, wherein:

at least one of the one or more jetting apertures delivers in use a jet of liquid which impacts the infusion or extraction ingredient or combination, mixture or composition of infusion or extraction ingredients with a vorticity in the range of 8 to 500 per second; and

the one or more jetting apertures comprise a total cross sectional area less than 16×10⁻⁶ m² (16 mm²).

In a twenty-first aspect, the present invention provides a pod for preparing a beverage comprising:

at least one compartment defining a storage volume for containing an infusion or extraction ingredient or combination, mixture or composition of infusion or extraction ingredients for forming a beverage;

the at least one compartment comprising an inlet surface containing one or more jetting apertures forming an inlet into the compartment, and an outlet surface formed at least partially from filtering material, the filtering material forming an outlet of the pod; and

the one or more jetting apertures of the inlet of the at least one compartment are arranged for jetting in use a liquid into the at least one compartment, wherein:

at least one of the one or more jetting apertures delivers in use a jet of liquid which impacts the infusion or extraction ingredient or combination, mixture or composition of infusion or extraction ingredients contained in the at least one compartment;

the unit area of the infusion or extraction ingredient or combination, mixture or composition of infusion or extraction ingredients available for the or each jet to impact is in the range of 0.02 to 0.6×10⁻⁶ m² (0.02 to 0.6 mm²); and

at least one of the one or more jetting apertures delivers in use a jet of liquid which impacts the infusion or extraction ingredient or combination, mixture or composition of infusion or extraction ingredients at a speed in the range of 15 to 500×10⁻² m/s (15 to 500 cm/s).

In a twenty-second aspect, the present invention provides a system substantially as hereinbefore described with reference to or as shown in the accompanying drawings.

In a twenty-third aspect, the present invention provides a pod substantially as hereinbefore described with reference to or as shown in the accompanying drawings.

Preferred embodiments of the present invention will now be described, by way of example only, with reference to the accompanying drawings in which:

FIG. 1 is a schematic perspective view in part section of a prior art pad;

FIG. 2 is a schematic exploded view of a prior art beverage preparation machine with the pad of FIG. 1 in position ready for preparing a beverage;

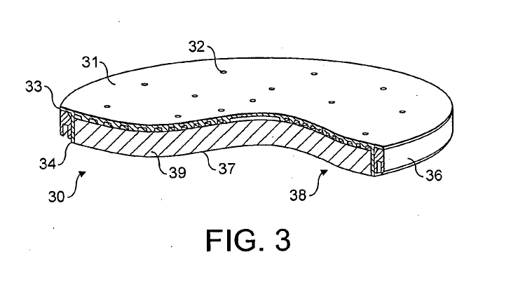

FIG. 3 is a schematic perspective view in part section of a rigid or semi-rigid pod according to a first preferred embodiment of the present invention;

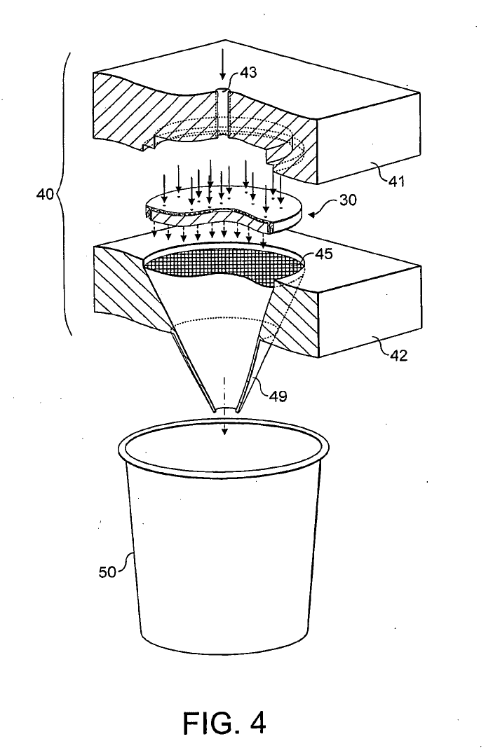

FIG. 4 is a schematic exploded view of a prior art beverage preparation machine with the rigid or semi-rigid pod of FIG. 3 in position ready for preparing a beverage;

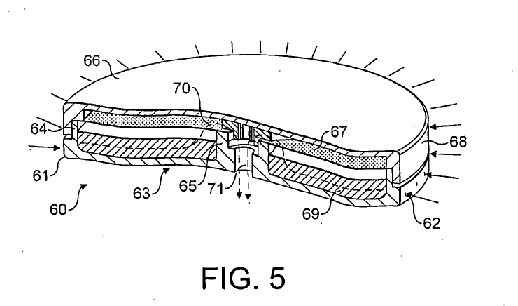

FIG. 5 is a schematic perspective view in part section of a rigid or semi-rigid pod according to a second preferred embodiment of the present invention;

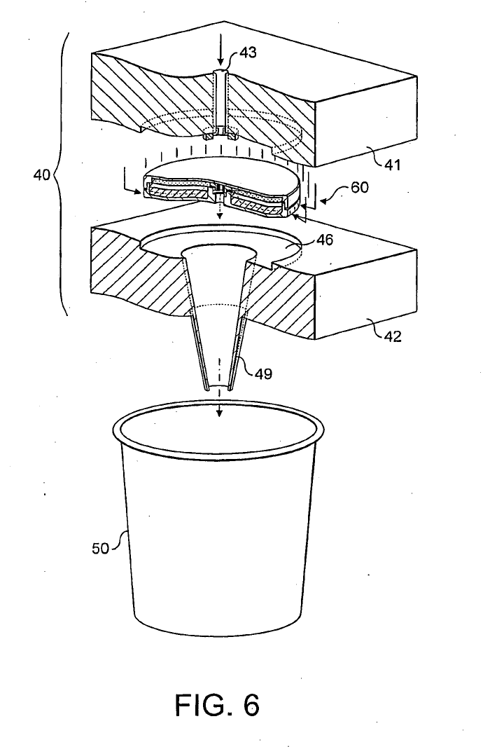

FIG. 6 is a schematic exploded view of a prior art beverage preparation machine with the rigid or semi-rigid pod of FIG. 5 in position ready for preparing a beverage;

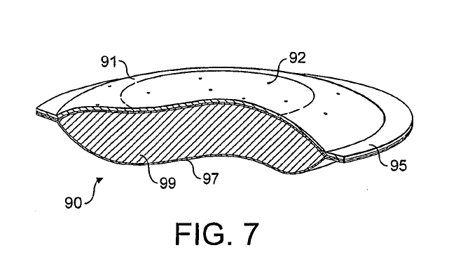

FIG. 7 is a schematic perspective view in part section of a flexible pod according to a third preferred embodiment of the present invention;

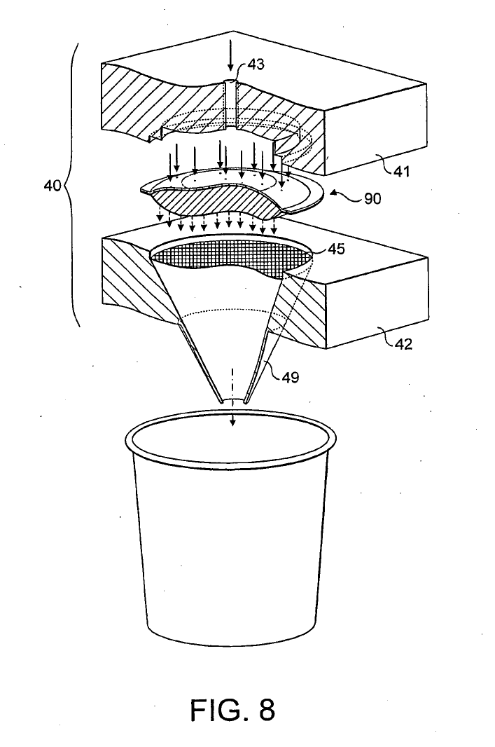

FIG. 8 is a schematic exploded view of a prior art beverage preparation machine with the flexible pod of FIG. 7 in position ready for preparing a beverage; and

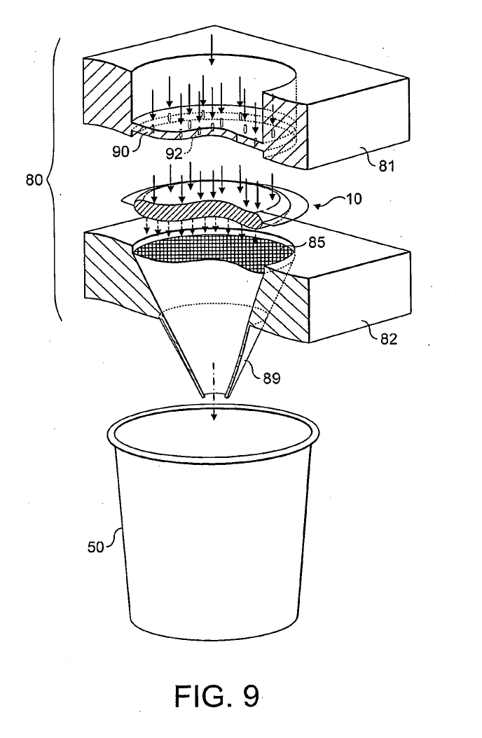

FIG. 9 is a schematic view of a beverage preparation machine according to a fourth preferred embodiment of the present invention with the prior art pad of FIG. 1 in position ready for preparing a beverage.

Referring first to FIG. 3, there is illustrated a rigid or semi-rigid pod 30 according to a first preferred embodiment of the present invention. The pod 30 comprises a rigid or semi-rigid inlet surface 31 provided with nineteen jetting apertures 32. The inlet surface 31 comprises a planar upper surface 33 and a downwardly dependent skirt 34 which is cylindrical in form and open-ended at a lower end thereof. A rigid or semi-rigid sealing ring 36 is provided which defines a side wall of the pod 30. The sealing ring 36 is frictionally engageable with the downwardly dependent skirt 34 of the inlet surface 31. During assembly of the pod 30, a layer of filtering material 37 is stretched across the open end of the downwardly dependent skirt 34 and the sealing ring 36 is engaged with the planar surface 33 of the inlet surface 31 so as to sandwich the layer of filtering material 37 between the sealing ring 36 and an outer surface of the downwardly dependent skirt 34. Assembly of the pod 30 in this manner stretches the layer of filtering material 37 across the distal lower rim of the downwardly dependent skirt 34 so as to form an outlet surface 38 of the pod 30. The frictional engagement of the sealing ring 36 and the downwardly dependent skirt 34 retains the layer of filtering material 37 securely. In an alternative method, the filtering material 37 can be bonded by heat, adhesive or ultrasonic welding to the downwardly dependent skirt 34 or, indeed, to the planar surface 33. A storage volume 39 is defined in the pod 30 by the inlet surface 31 and the layer of filtering material 37. The storage volume 39 contains a measure of a water infusible ingredient used to prepare the beverage. The water infusible ingredient may be roast and ground coffee, leaf tea, herbal tea, fruit tea or indeed any other such water infusible ingredient. The invention finds particular application where the water infusible ingredient is an extraction ingredient of roast and ground coffee. The inlet surface 31, and sealing ring 36 are both formed from a rigid or semi-rigid material such as polypropylene, polyester, polystyrene, nylon, polyurethane, acetal, acetal grade polyoxylene methylene copolymer (e.g. Centrodal C), polymers (e.g. polypropylene, polystyrene, polyamide, polyvinyl chloride, polyethylene and its derivatives and mixtures thereof), other engineering plastics, composites, ceramics, aluminium grade HE30, stainless steel, brass, other metals, metal-plastic composites, card, wood, rubber or biodegradable plastics such as degradable polyethylene (for example, SPITEK supplied by Symphony Environmental, Borehamwood, United Kingdom), biodegradable polyester amide (for example, BAK 1095 supplied by Symphony Environmental), poly lactic acids (PLA supplied by Cargill, Minnesota, USA), starch-based polymers, cellulose derivatives and polypeptides. An ideal semi-rigid material is polypropylene homo polymer for injection moulding (e.g. Sabic PP 579S). The material may be pressed, stamped, machined, thermo formed, compression moulded or injection moulded.

In use, with reference to FIG. 4, the pod 30 is placed in a suitable support structure 42 of a beverage preparation machine 40. Preferably, the pod 30 is provided with a sealing means, not illustrated, for sealing the pod against the beverage preparation machine 40 to avoid water bypass. This could, for example, take the form a resilient flange seal between the sealing ring 36 and brewer head 41 or be the sealing 36 itself (a rubber element, for example). Liquid, typically water or a beverage extract, is pumped through a brewer head 41 via an inlet 43. The liquid enters the storage volume 39 of the pod 30 through the jetting apertures 32. In the embodiment shown, the jetting apertures 32 are arranged perpendicular to the planar upper surface 33 so as to direct jets of liquid into the storage volume 39 in a direction perpendicular to the planar surface 33 of the inlet surface 31. In an alternative, non-illustrated embodiment, the jetting apertures 32 may be angled so as to direct jets of liquid into the storage volume 39 in a radial, other or random direction so as to impact, impinge on and agitate the water infusible ingredient contained in the storage volume 39. The liquid infuses the water infusible ingredient and the resulting beverage extract or beverage infusion is then able to pass through the outlet surface 38 of filtering material 37, passing through a pod supporting mesh 45 of the beverage preparation machine 40 and through an outlet 49 into a receptacle 50. After use, a user of the beverage preparation machine 40 may remove the pod 30 and dispose of it in a waste receptacle. Advantageously, the rigidity of the pod 30 imparted by the rigid or semi-rigid inlet surface 31 and of the sealing ring 36 makes for easier handling of the pod 30 compared to the prior art pad of FIG. 1.

Referring next to FIG. 5, there is illustrated a rigid or semi-rigid pod 60 according to a second preferred embodiment of the present invention. The pod 60 comprises a rigid or semi-rigid inlet surface 61 provided with nineteen jetting apertures 62. The inlet surface 61 comprises a planar lower surface 63 having an upwardly dependent skirt 64 at an outer periphery and an upwardly dependent core member 65 at the centre. The upwardly dependent skirt 64 and core member 65 together define an open-topped annular storage volume 69 which is closed at the bottom by the planar lower surface 63. A rigid or semi-rigid cap member 66 having a downwardly dependent skirt 68 is provided and is designed to co-operate with, so as to frictionally engage, the upwardly dependent skirt 64 of the inlet surface 61. During assembly of the pod 60, a layer of filtering material 67 is stretched across the open-topped annular storage volume 69 over the upwardly dependent skirt 64 and core member 65, and then the cap member 66 is engaged with the inlet surface 61 so as to sandwich the layer of filtering material 67 between the downwardly dependent skirt 68 and an outer surface of the co-operating upwardly dependent skirt 64. Assembly of the pod 60 in this manner stretches the layer of filtering material 67 across the upper rim of the upwardly dependent skirt 64 and core member 65 so as to form an outlet surface 70 of the pod 60. The frictional engagement of the downwardly dependent skirt 68 and an outer surface of the co-operating upwardly dependent skirt 64 retains the layer of filtering material 67 securely. In an alternative method, the filtering material 67 can be bonded by heat, adhesive or ultrasonic welding to the upwardly dependent skirt 64. The storage volume 69 defined in the pod 60 by the inlet surface 61 and the layer of the filtering material 67 contains a measure of a water infusible ingredient used to prepare the beverage. Again, the inlet surface 61 and cap member 66 are both formed from a rigid or semi-rigid material such as polypropylene, polyester, polystyrene, nylon, polyurethane, acetal, acetal grade polyoxylene methylene copolymer, polymers (e.g. polypropylene, polystyrene, polyamide, polyvinyl chloride, polyethylene and its derivatives and mixtures thereof), other engineering plastics, composites, ceramics, aluminium grade HE30, stainless steel, brass, other metals, metal-plastic composites, card, wood, rubber or biodegradable plastics such as degradable polyethylene, biodegradable polyester amide, poly lactic acids, starch-based polymers, cellulose derivatives and polypeptides as described above. An ideal semi-rigid material is polypropylene homo polymer for injection moulding. The material may be pressed, stamped, machined, thermo formed, compression moulded or injection moulded.

In use, with reference to FIG. 6, the pod 60 is placed in a suitable support structure 42 of a beverage preparation machine 40. Preferably, the pod 60 is provided with a sealing means, not illustrated, for sealing the pod against the beverage preparation machine 40 to avoid water bypass. This could, for example, take the form an O-ring seal between the planar lower surface 63 and supporting land 46. Liquid, typically water or a beverage extract, is pumped through a brewer head 41 via an inlet 43. The liquid enters the storage volume 69 of the pod 60 through the jetting apertures 62. In the embodiment shown, the jetting apertures 62 are arranged parallel to the outlet surface 70 so as to direct jets of liquid into the storage volume 69 in a direction parallel to the outlet surface 70. In an alternative, non-illustrated embodiment, the jetting apertures 62 may be angled so as to direct jets of liquid into the storage volume 69 in a radial, other or random direction so as to impact, impinge on and agitate the water infusible ingredient contained in the storage volume 69. Alternatively, the jetting apertures may located in the planar surface 63. The liquid infuses the water infusible ingredient contained in the storage volume 69 and the resulting beverage extract or beverage infusion is then able to pass up through the outlet surface 70 of filtering material 67, leaving the pod 60 via an outlet 71 in the central core 65 (as indicated in dotted line). The beverage extract or beverage infusion then passes through an outlet 49 provided in the pod supporting land 46 of the beverage preparation machine 40 through into a receptacle 50. After use, a user of the beverage preparation machine 40 may remove the pod 60 and dispose of it in a waste receptacle. Advantageously, the rigidity of the pod 60 imparted by the rigid or semi-rigid inlet surface 61 and of the cap member 66 makes for easier handling of the pod 60 compared to the prior art pad of FIG. 1.

Referring next to FIG. 7, there is illustrated a flexible pod 90 according to a third preferred embodiment of the present invention. The pod 90 comprises a flexible inlet surface 91 provided with nineteen jetting apertures 92 and a lower sheet of filter material 97. These are bonded together around a peripheral seam 95 to define and seal a storage volume 99 in which the water infusible substance is contained. The flexible inlet surface 91 may be formed from a material such as a thin, flexible, sheet of food grade material with low porosity, e.g. any one or more of polyethylene, polypropylene, polyesters including polyethylene terephthalate, polyvinyl chloride, polyvinylidene chloride, polyamides including nylon, polyurethane, paper, viscose and/or foil. Furthermore, it may comprise a laminate, be metallised or formed of copolymers.

In use, with reference to FIG. 8, the pod 90 is placed on a support structure 45 of a beverage preparation machine 40 and clamped between the brewer head 41 and lower support structure 42 to avoid water bypass. Liquid, typically water or a beverage extract, is pumped through the brewer head 41 via an inlet 43 and through the jetting apertures 92 of the inlet surface. The jetting apertures 92 are arranged to direct jets of liquid into the storage volume 99 in a normal, radial, other or random direction so as to impact, impinge on and agitate the water infusible ingredient contained in the storage volume 99. The liquid infuses the water infusible ingredient contained in the storage volume 99 and the resulting beverage extract or beverage infusion is then able to pass through the lower sheet of filtering material 97, leaving the pod 90, and passing through a pod supporting mesh 45 of the beverage preparation machine 40. The beverage extract or beverage infusion then passes through an outlet 49 and into a receptacle 50. After use, a user of the beverage preparation machine 40 may remove the pod 90 and dispose of it in a waste receptacle.

In FIG. 9, there is illustrated a schematic view of a beverage preparation machine according to a fourth preferred embodiment of the present invention. The beverage preparation machine 80 differs from prior art beverage preparation machines in that there is provided a rigid, semi-rigid or flexible inlet surface 90 provided with nineteen jetting apertures 92. The inlet surface 90 may be an integral part of the brewer head 81, as illustrated, or may take the form of an insert. Indeed, the inlet surface 90 may be a retrofit part for use with a prior art beverage preparation machine. Again, the inlet surface 90 may be formed from a rigid or semi-rigid material such as polypropylene, polyester, polystyrene, nylon, polyurethane, acetal, acetal grade polyoxylene methylene copolymer, polymers (e.g. polypropylene, polystyrene, polyamide, polyvinyl chloride, polyethylene and its derivatives and mixtures thereof, other engineering plastics, composites, ceramics, aluminium grade HE30, stainless steel, brass, other metals, metal-plastic composites, card, wood, rubber or biodegradable plastics such as degradable polyethylene, biodegradable polyester amide, poly lactic acids, starch-based polymers, cellulose derivatives and polypeptides as described above. An ideal semi-rigid material is polypropylene homo polymer for injection moulding. The material may be pressed, stamped, machined, thermo formed, compression moulded or injection moulded. Alternatively, the inlet surface 90 may be formed from a flexible material such as a thin, flexible, sheet of food grade material with low porosity, e.g. any one or more of polyethylene, polypropylene, polyesters including polyethylene terephthalate, polyvinyl chloride, polyvinylidene chloride, polyamides including nylon, polyurethane, paper, viscose and/or foil. Furthermore, it may comprise a laminate, be metallised or formed of copolymers.

The beverage preparation machine 80 can make use of a conventional pad 10. The pad 10 is simple in construction and comprises a circular upper sheet 11 and a circular lower sheet 12 of filter material which are bonded together around a peripheral seam 15 to define and seal a storage volume 13 in which the water infusible substance 14 is contained. In use, the pad 10 is placed on a support structure 85 of the beverage preparation machine 80 according to the present invention, typically a mesh, and clamped between the brewer head 81 and lower support structure 82 to avoid water bypass. Liquid, typically water or a beverage extract, is pumped through the brewer head 81 through the jetting apertures 92. In the embodiment shown, the jetting apertures 92 are arranged perpendicular to the horizontal plane of the brewer head 81 so as to direct jets of liquid into the pad 10 in a direction perpendicular to the major cross sectional plane of the pad 10. In an alternative non-illustrated embodiment, the jetting apertures 92 may be angled so as to direct jets of liquid into the storage volume 14 in a radial, other or random direction so as to impact, impinge on and agitate the water infusible ingredient contained in the storage volume 14. The liquid infuses the water infusible ingredient contained in the storage volume 14 and the resulting beverage extract or beverage infusion is then able to pass through the lower sheet of filtering material 12, leaving the pod 10. The beverage extract or beverage infusion then passes through a pod supporting mesh 85 of the beverage preparation machine 80 through an outlet 89 and into a receptacle 50. After use, a user of the beverage preparation machine 80 may remove the pod 10 and dispose of it in a waste receptacle.

It has been found that these preferred embodiments of system, pod and method of preparing a beverage according to the present invention advantageously provide an improved quality of beverage when compared to prior art systems and pods.

In support of this position, reference now is made to Tables 1 and 2 below. Table 1 shows the results of measured improvements in aroma for a rigid, flexible and semi-rigid pod according to the present invention against a standard prior art filter paper pod. Table 2 shows the results of measured improvements in aroma compounds for a system according to the present invention against a standard prior art system.

The method used was measurement of aroma compounds recovered by Liquid Liquid Extraction (LLE) using dichloromethane as extraction solvent. The % increase is on a total value of aroma compounds, based on an average of multiple repeats. Samples were five fold replicated. For each repetition, a Williams Latin Square presentation design was followed to analyse the sample (i.e. within each repetition, the samples were all analysed in a random order) and a reference/target were randomly included.

TABLE 1
Pod

| | | | Total | Drink | Mass | | Total Aroma | Significant |
|---|---|---|---|---|---|---|---|---|
| | | Pod Design | Area | Temperature | Flow-rate | Speed | Compounds vs. | Increase |
| Sample | Measure | Details | (mm²) | (° C.) | (g/s) | (cm/s) | Reference (%) | in AC vs. Ref |
| Rigid | Average | 19 holes @ | 5.4 | 71.8 | 2.99 | 56 | +11 | Yes (at 90% |
| | Std Dev | 0.6 mm Ø | | 1.5 | 0.03 | — | | confidence level) |
| Reference | Average | Filter paper pod | 48.1 | 71.2 | 3.12 | 6.5 | | |
| | Std Dev | | | 1.9 | 0.1 | — | | |
| Flexible | Average | 19 holes in | 1.2 | 64 | 3.39 | 283 | +45 | Yes (at 95% |
| | Std Dev | flexible top sheet | | 3.8 | 0.44 | — | | confidence level) |
| Reference | Average | Filter paper pod | 48.1 | 71.1 | 3.10 | 6.4 | | |
| | Std Dev | | | 2.9 | 0.33 | — | | |
| Semi- | Average | 19 holes @ | 2.8 | 69.5 | 3.61 | 97 | +11 | Yes (at 95% |
| Rigid | Std Dev | 0.5 mm Ø | | 2.4 | 0.09 | — | | confidence level) |
| Reference | Average | Filter paper pod | 39.0 | 69.8 | 3.72 | 9.5 | | |
| | Std Dev | | | 2.4 | 0.16 | — | | |

TABLE 2
System

| | | | Total | Drink | Mass | | Total Aroma | Significant |
|---|---|---|---|---|---|---|---|---|
| | | System Design | Area | Temperature | Flow-rate | Speed | Compounds vs. | Increase |
| Sample | Measure | Details | (mm²) | (° C.) | (g/s) | (cm/s) | Reference (%) | in AC vs. Ref |
| Rigid | Average | 14 holes @ | 2.8 | 62.3 | 3.57 | 130 | +80 | Yes (at 95% |
| | Std Dev | 0.5 mm Ø | | 0.9 | 0.26 | — | | confidence level) |
| Reference | Average | Prior Art known | 39.0 | 66.5 | 3.78 | 9.7 | | |
| | Std Dev | brewer | | 3.9 | 0.36 | — | | |

AC = Aroma Compounds

The measurements and analysis show, with a 90% or 95% standard statistical confidence level, that the preferred embodiments of system, pod and method of preparing a beverage according to the present invention advantageously provide an improved quality of beverage when compared to prior art systems and pods.

Of paramount importance are the jetting apertures which act to impart into the liquid passing through the pod the desired characteristics according to the present invention of speed, power, vorticity and area of available water infusible product for impact, which optimise the quality of the resultant beverage. The number of jetting apertures, their cross-sectional area and position relative to the contained storage volume of water infusible ingredient are critical to the quality of the resultant beverage as set out in the statements of invention and appended claims.

Reference herein to the terms “impacts at a speed”, “impacts with a power” and “impacts with a vorticity” refer to the respective measured property of the jet of liquid immediately prior to coming into contact with the water infusible ingredient.

Reference herein to the following terms/measurements take the given meaning/units:

Brew time—is the time it takes to prepare a beverage, measured in seconds;

Brew weight—is the mass of the drink (brewed drink) recorded in grams, rather than in volume (ml), whereby the mass of the cup/container of the drink is not included;

Coffee weight—is the mass of the roast and ground coffee, measured in grams, contained within a specific volume to prepare a single cup of beverage;

Brew yield—the % brew yield=the mass of coffee (or infusion/extraction substances) solids in the final brewed drink (measured in grams) divided by the initial mass of coffee (measured in grams), then multiplied by 100;

Mass flow rate—the mass of fluid that flows in a given time;

Mass flow rate=mass (g)/time (s);

Volumetric flow rate—the volume of fluid that flows in a given time;

Volumetric flow rate=volume (cm³)/time (s);

Volumetric flow rate=mass flow rate (g s⁻¹)/density (g cm⁻³);

Velocity—a vector quantity whose magnitude is a body's speed and whose direction is the body's direction of motion (cm s⁻¹);

Speed—distance travelled divided by the time of travel;

Power—the rate at which work is done, expressed as the amount of work per unit time and commonly measured in unit such as the watt;

Vorticity—a measure of the rate of rotational spin in a fluid; and

Cross sectional area—a section formed by a plane cutting through an object, usually at right angles to an axis.

It will be appreciated that the preferred embodiments described above are non-limiting examples for the purposes of illustrating the present invention and that many different configurations of system and pod are possible within the scope of the invention is as set out in the appended claims.

By way of example, the pod storage volume described may also be provided with a dispersion plate which is freely moveable within the storage volume.

The pod may be used inverted. The order in which water passes through the pod is identical to the manner of use mentioned above. However, the beverage preparation machine is arranged to pass water through the pod using reverse filtration, i.e. filtration against the force of gravity, so that the inlet of the pod is positioned at the bottom of the pod (by inversion of the pod) and filtration then occurs in an upwards direction—against the force of gravity.

The pod may comprise a gasket seal on an underside of an outwardly directed flange.

The storage volume may also contains a spongiform element in the form of a circular disc of compressed sponge material. The disc has preferred diameters of 10 to 80 mm, 20 to 60 mm and 30 to 40 mm and a thickness of 3 mm. The disc is formed from cellulose sponge such as that manufactured by 3M. Other suitable materials for the spongiform element include other food grade materials with similar physical properties to those of cellulose sponge in terms of there porosity and or expandability.

Prior to use of the pod, the pod and its contents are dry. If necessary, the pod can be supplied in an hermetically sealed package to prevent moisture ingress or absorption.

In use, the pod is used as described above. On contact with the water, the compressed sponge rapidly expands. In the expanded state the disc has a thickness of between 10 and 20 mm, preferably around 15 mm. Thus, the action of the liquid on the compressed sponge is to produce an expansion in the thickness of the compressed sponge of around 500%. The compressed sponge may be configured to expand generally only in one dimension, i.e. its thickness, or may be configured to expand three-dimensionally, i.e. to increase its thickness and also its diameter. Water is able to pass through the expanded compressed sponge substantially unhindered.

Advantageously, the porous water-retaining nature of the spongiform element helps to retain excess moisture that may be within the pod. The capillary action of the pores of the spongiform element help to prevent dripping from the pod as it is transferred to a waste receptacle. In addition, the water-retaining nature of the spongiform element has the consequence that the pod holding section of the beverage preparation machine contains less moisture and hence less contamination than compared with the use of prior art pads. As a result the machine is easier to clean and prepare in readiness for the next dispense cycle.

The pod may contain spherical spongiform particles. The particles may take other forms such as block shapes, irregular shapes or be formed as shredded portions of a sheet material.

In an alternative, the storage volume also contains a plurality of absorbent particles in the form of particles of compressed sponge material. The particles are each of a size (diameter or length) of 1 to 10 mm and a thickness of 1 to 3 mm before use. The particles are formed from compressed cellulose sponge. Preferably the ratio by weight of the water infusible ingredient to the absorbent particles before use is from 20:1 to 2:1, preferably around 3:1.

The compressed particles are dispersed throughout the water infusible ingredient within the storage chamber.

In use, the pod is used as described above. On contact with the water, the compressed particles rapidly expand. In the expanded state the discs have a thickness of around 15 mm. The diameter of the particles is not substantially changed, i.e. the expansion is uni-directional. Thus, the action of the liquid on the compressed sponge is to produce an expansion in the compressed sponge of around 500%. Water is able to pass through the expanded sponge substantially unhindered.

Advantageously, the porous water-retaining nature of the spongiform particles helps to retain excess moisture that may be within the pod. The capillary action of the pores of the spongiform particles help to prevent dripping from the pad as it is transferred to a waste receptacle. In addition, the water-retaining nature of the spongiform particles has the consequence that the pad holding section of the beverage preparation machine contains less moisture and hence less contamination than compared with the use of prior art pads. As a result the machine is easier to clean and prepare in readiness for the next dispense cycle.

In another, non-illustrated, embodiment, the spongiform discs are replaced by particles of a hydrogel, starch or a combination thereof. The particles are in the form of spherical or otherwise shaped particles. In use, and on contact with water, the hydrogel or other absorbent material absorbs water and expands.

The pods of the present invention may also comprise one or more seals to allow for improved engagement of the pod with a pod holder of the beverage preparation machine. Seals may be provided on or adjacent an upper edge of the pod or flange, on an outer surface of the sidewall of the pod, and on or adjacent a lower edge of the sidewall of the pod. The seals help to prevent water by-pass by reducing or eliminating the quantity of water that does not pass through the pod.

The pods of the present invention may also be provided with an aperture at or near the outlet through which the beverage is forced to form a jet of beverage. The jet of beverage can then be impacted against an impingement surface to create foaming of the beverage.

In the above description, the storage volume has been described as a unitary volume. However, the volume may be separated into multiple compartments using rigid or flexible materials. The chambers may if desired contain different water infusible ingredients or the same water infusible ingredients. Some or all of the compartments may comprise absorbent bodies of the types described above. Some or all of the compartments may have dispersion discs contained therein.

The pod may be used for dispensing hot and cold beverages. Still and carbonated beverages may be produced by using still or carbonated water.

The absorbent particles may be formed from a hydrogel, starch or a mixture of one or more of spongiform, starch and hydrogel materials with a particle size of 25 microns to 10 mm.

The pod may be provided with an upper cover for sealing prior to use. The cover may be a push fit or preferably, a laminate or tear off element that seals around the upper edge of the pod and/or to the upper surface of a flange. The cover serves to maintain the freshness of the storage volume. In order to ready the pod for brewing the cover is simply removed, peeled or torn off. In addition, the pod may be provided with a further filtering material which seals around the upper edge of the pod and/or to the upper surface of the pod.

1-245. (canceled)

246. A pod for preparing a beverage comprising:
at least one compartment defining a storage volume for containing an infusion or extraction ingredient or combination, mixture or composition of infusion or extraction ingredients for forming a beverage;
the at least one compartment comprising an inlet surface containing one or more jetting apertures forming an inlet into the compartment, and an outlet surface formed at least partially from filtering material, the filtering material forming an outlet of the pod; and
the one or more jetting apertures of the inlet of the at least one compartment are arranged for jetting in use a liquid into the at least one compartment, wherein:
the pod operates in use at a pressure of less than 8.5×10⁵ Pa (8.5 bar);
at least one of the one or more jetting apertures delivers in use a jet of liquid which impacts the infusion or extraction ingredient or combination, mixture or composition of infusion or extraction ingredients contained in the at least one compartment at a speed in the range of 15 to 500×10⁻² m/s (15 to 500 cm/s); and
the one or more jetting apertures comprise a total cross sectional area less than 16×10^{-6 m}² (16 mm²).

247. A pod as in claim 246 wherein at least one of the one or more jetting apertures delivers in use a jet of liquid as a discontinuous flow.

248. A pod as in claim 246 wherein the outlet permits in use free flow of liquid extract out of the pod.

249. A pod as in claim 246 wherein the filtering material is bonded to a flange, located at or around an edge of the at least one compartment, a side wall of the at least one compartment, or a lower surface of a side wall of the at least one compartment.

250. A pod as in claim 246 further comprising a cover for sealing the at least one compartment.

251. A pod as in claim 246 further comprising means at or near an outlet for the beverage for foaming the beverage.

252. A pod for preparing a beverage comprising:
at least one compartment defining a storage volume for containing an infusion or extraction ingredient or combination, mixture or composition of infusion or extraction ingredients for forming a beverage;
the at least one compartment comprising an inlet surface containing one or more jetting apertures forming an inlet into the compartment, and an outlet surface formed at least partially from filtering material, the filtering material forming an outlet of the pod; and
the one or more jetting apertures of the inlet of the at least one compartment are arranged for jetting in use a liquid into the at least one compartment, wherein: at least one of the one or more jetting apertures delivers in use a jet of liquid which impacts the infusion or extraction ingredient or combination, mixture or composition of infusion or extraction ingredients contained in the at least one compartment with a power in the range of 0.000075 to 0.15 J/s (750 to 1500000 erg/s); and the one or more jetting apertures comprise a total cross sectional area less than 16×10⁻⁶ m² (16 mm²).

253. A pod as in claim 252 wherein at least one of the one or more jetting apertures delivers in use a jet of liquid as a discontinuous flow.

254. A pod as in claim 252 wherein the outlet permits in use free flow of liquid extract out of the pod.

255. A pod as in claim 252 wherein the outlet permits in use free flow of liquid extract out of the pod.

256. A pod as claimed as in claim 252 wherein the filtering material is bonded to a flange, located at or around an edge of the at least one compartment, a side wall of the at least one compartment, or a lower surface of a side wall of the at least one compartment.

257. A pod as claimed as in claim 252 further comprising a cover for sealing the at least one compartment.

258. A pod as in claim 252 further comprising means at or near an outlet for the beverage for foaming the beverage.

259. A pod for preparing a beverage comprising:
at least one compartment defining a storage volume for containing an infusion or extraction ingredient or combination, mixture or composition of infusion or extraction ingredients for forming a beverage;
the at least one compartment comprising an inlet surface containing one or more jetting apertures forming an inlet into the compartment, and an outlet surface formed at least partially from filtering material, the filtering material forming an outlet of the pod; and
the one or more jetting apertures of the inlet of the at least one compartment are arranged for jetting in use a liquid into the at least one compartment, wherein: at least one of the one or more jetting apertures delivers in use a jet of liquid which impacts the infusion or extraction ingredient or combination, mixture or composition of infusion or extraction ingredients with a vorticity in the range of 8 to 500 per second; and
the one or more jetting apertures comprise a total cross sectional area less than 16×10⁻⁶ m² (16 mm²).

260. A pod as in claim 259 wherein at least one of the one or more jetting apertures delivers in use a jet of liquid as a discontinuous flow.

261. A pod as in claim 259 wherein the outlet permits in use free flow of liquid extract out of the pod.

262. A pod as in claim 259 wherein the outlet permits in use free flow of liquid extract out of the pod.

263. A pod as in claim 259 wherein the filtering material is bonded to a flange, located at or around an edge of the at least one compartment, a side wall of the at least one compartment, or a lower surface of a side wall of the at least one compartment.

264. A pod as in claim 259 further comprising a cover for sealing the at least one compartment.

265. A pod as in claim 259 further comprising means at or near an outlet for the beverage for foaming the beverage.

266. A pod for preparing a beverage comprising:
at least one compartment defining a storage volume for containing an infusion or extraction ingredient or combination, mixture or composition of infusion or extraction ingredients for forming a beverage;
the at least one compartment comprising an inlet surface containing one or more jetting apertures forming an inlet into the compartment, and an outlet surface formed at least partially from filtering material, the filtering material forming an outlet of the pod; and
the one or more jetting apertures of the inlet of the at least one compartment are arranged for jetting in use a liquid into the at least one compartment, wherein:
at least one of the one or more jetting apertures delivers in use a jet of liquid which impacts the infusion or extraction ingredient or combination, mixture or composition of infusion or extraction ingredients contained in the at least one compartment; the unit area of the infusion or extraction ingredient or combination, mixture or composition of infusion or extraction ingredients available for the or each jet to impact is in the range of 0.02 to 0.6×10⁻⁶ m² (0.02 to 0.6 mm²);
and at least one of the one or more jetting apertures delivers in use a jet of liquid which impacts the infusion or extraction ingredient or combination, mixture or composition of infusion or extraction ingredients at a speed in the range of 15 to 500×10⁻² m/s (15 to 500 cm/s).

267. A pod as in claim 266 wherein at least one of the one or more jetting apertures delivers in use a jet of liquid as a discontinuous flow.

268. A pod as in claim 266 wherein the outlet permits in use free flow of liquid extract out of the pod.

269. A pod as in claim 266 wherein the outlet permits in use free flow of liquid extract out of the pod.

270. A pod as in claim 266 wherein the filtering material is bonded to a flange, located at or around an edge of the at least one compartment, a side wall of the at least one compartment, or a lower surface of a side wall of the at least one compartment.

271. A pod as in claim 266 further comprising a cover for sealing the at least one compartment.

272. A pod as in claim 266 further comprising means at or near an outlet for the beverage for foaming the beverage.
